(19) United States
(12) Patent Application Publication
(10) Pub. No.: US 2014/0026153 A1
(43) Pub. Date: Jan. 23, 2014

(54) SYSTEMS AND METHODS FOR BUYING, SELLING, AND MANAGING ADVERTISING SPACE IN A TELEVISION BROADCAST

(71) Applicant: Magnus Sorlander, La Jolla, CA (US)

(72) Inventor: Magnus Sorlander, La Jolla, CA (US)

(73) Assignee: VIGOR SYSTEMS INC., La Jolla,CA (US)

(21) Appl. No.: 13/820,120

(22) PCT Filed: Sep. 1, 2011
(86) PCT No.: PCT/US11/50149

§ 371 Date: May 13, 2013

Related U.S. Application Data
(60) Provisional application No. 61/379,344, filed on Sep. 1, 2010.
(60) Provisional application No. 61/379,343, filed on Sep. 1, 2010.
(60) Provisional application No. 61/379,336, filed on Sep. 1, 2010.

(51) Int. Cl. H04N 21/2543

(52) U.S. Cl. CPC H04N 21/2543
USPC 725/5

(57) ABSTRACT

Systems and methods for managing commercial advertising in a television broadcast, as well as the management of the sale and/or purchase of time slots for the insertion of audiovisual media, such as a commercial advertisement, are provided. The management includes providing a web-based television advertising marketplace for the sale and purchase of time slots for commercial advertisements in a television broadcast. A central management system also provides for the receipt, conversion, reviewing, scheduling and insertion of the commercial advertisement into a television broadcast stream. Advertisers and broadcasters accessing the systems use a web-based application to manage the entire workflow remotely.

### CROSS REFERENCE TO RELATED APPLICATIONS

This application claims the benefit under 35 U.S.C. §119(e) to U.S. Provisional Application No. 61/379,336, filed Sep. 1, 2010; U.S. Provisional Application No. 61/379,343, filed Sep. 1, 2010; and U.S. Provisional Application No. 61/379,344, filed Sep. 1, 2010. The disclosure of each of which is considered part of and is incorporated by reference in the disclosure of this application.

### BACKGROUND

1. Field of the Invention

This invention relates to systems and methods for managing commercial advertisements in a television broadcast, and more specifically to managing the selling and buying of a time slot for a commercial advertisement, along with the scheduling and insertion of audiovisual media such as a commercial advertisement in a television broadcast signal.

2. Description of the Related Art

Television advertising is expensive, although it is a highly-effective advertising medium. The cost required to plan and produce a television commercial is prohibitively high for many businesses. Likewise, the infrastructure set up by the television industry to buy and sell advertising space is exceedingly complex. In order to sell advertising space, each television station must employ numerous individuals to market the available advertising slots, manage a particular advertiser or advertising campaign, and schedule and broadcast the advertisement in a desired time slot. As a result, the revenue from the sale of a particular advertising slot must be high enough to cover the cost of this infrastructure. Television stations thus require advertisers to purchase large blocks of advertisement time, which is cost-prohibitive for many businesses.

In a smaller television market, such as a television station in a small town, the number of businesses which can afford this level of advertising is limited. Likewise, the cost for the television station to support a full advertising staff is proportionately higher when the limited amount of potential buyers is taken into account. Even in a large television market, numerous television stations are not affiliated with a national network and have narrower audiences with a more limited number of potential advertisers. These television stations are not able to sell all of their available advertising space, and will therefore run duplicate or filler commercials that generate little or no additional revenue.

Even when a particular television commercial has been created, placing the advertisement in a particular slot in a television broadcast requires additional technical capabilities. The video of the commercial must be converted into a format compatible with each television station's broadcast video and audio format. The television station engineers must convert the commercial to the proper formats and then insert it in the appropriate time slots. The conversion and scheduling process is time consuming and complex, which places additional burdens on a small market television station.

In some areas of the country, a television station may broadcast its signal over multiple antennas to separate areas, for example a large rural area with several smaller towns. The television station sends out a single broadcast signal with inserted commercials for a business that may only be present in one of the towns. The advertiser is thus paying to advertise to areas where they have no business interest, and the television station is not able to sell advertising space for each individual market within its broadcast range.

### SUMMARY

The systems and methods described herein provide for the management of the sale and purchase of time slots for a commercial advertisement in a television broadcast, including the selection, transmission, receipt, conversion, scheduling and insertion of the commercial into a television broadcast stream. Users accessing the systems, whether advertisers or broadcasters, use a web-based application to manage the entire workflow from selecting a time slot to purchase, uploading a commercial advertisement by an advertiser, review of the commercial advertisement for the time slot purchased, to inserting the commercial advertisement into the broadcast stream.

Additional aspects related to the invention will be set forth in part in the description which follows, and in part will be apparent from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. Specifically:

FIG. 1 illustrates a system for managing commercials advertisements in a television broadcast, according to one embodiment of the invention;

FIG. 2 illustrates a method of managing commercial advertisements in the television broadcast, according to one embodiment of the invention;

FIG. 3 illustrates a method of selling time slots for commercial advertisements in the television broadcast, according to one embodiment of the invention;

FIG. 4 illustrates another embodiment of a method for selling time slots for commercial advertisements in a television broadcast;

FIG. 5 illustrates a method of purchasing time slots for commercial advertisements in the television broadcast, according to one embodiment of the invention;

FIG. 6 illustrates another embodiment of a method for purchasing time slots for commercial advertisements in a television broadcast; and

FIG. 7 is a block diagram of a computer system upon which the system may be implemented.

### DETAILED DESCRIPTION

In the following detailed description, reference will be made to the accompanying drawings. The aforementioned accompanying drawings show by way of illustration, and not by way of limitation, specific embodiments and implementations consistent with principles of the present invention. These implementations are described in sufficient detail to enable those skilled in the art to practice the invention, and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

In one aspect, the systems and methods described herein provide for the management of the sale and purchase of a commercial advertisement for a television broadcast, including the receipt, conversion, scheduling and insertion of the commercial into a television broadcast stream. Users accessing the systems, whether advertisers or broadcasters, use a web-based application to manage the entire workflow from uploading a commercial advertisement to inserting the commercial advertisement into the broadcast stream.

In another aspect, the systems and methods described herein provide for the sale of a time slot for insertion of audiovisual media (e.g., a commercial advertisement) in a television broadcast, including the receipt, conversion, review, scheduling and insertion of the audiovisual media (e.g., commercial advertisement) into a television broadcast stream. A broadcaster selling time slots accesses the system using a web-based application to manage the entire workflow from selecting time slots to offer for sale to receipt and review of a commercial advertisement for the time slot purchased by an advertiser.

In yet another aspect, the systems and methods described herein provide for the purchase of a time slot for insertion of audiovisual media (e.g., a commercial advertisement) in a television broadcast, including the selection, transmission, conversion, scheduling and insertion of the commercial into a television broadcast stream. An advertiser purchasing time slots accesses the system using a web-based application to manage the entire workflow from selecting time slots to purchase all the way to uploading of a commercial advertisement for the purchased time slot.

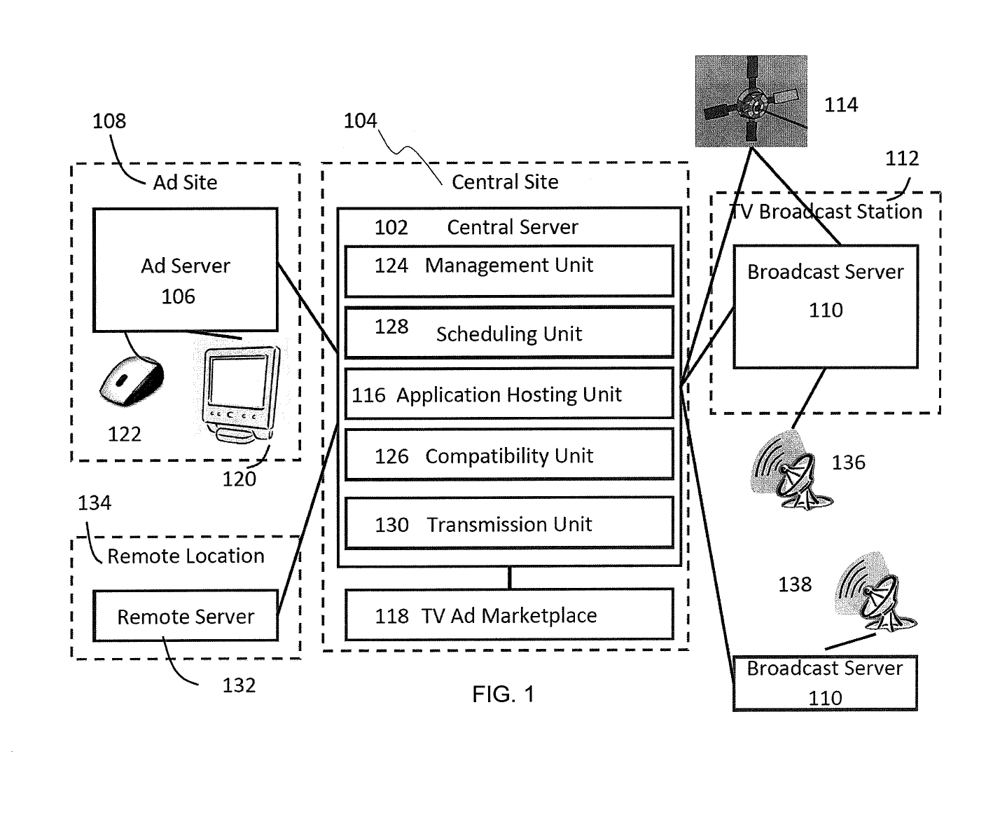

An overview of one embodiment of the system 100 is illustrated in FIG. 1, where a central server 102 located at a central site 104 is connected, via a network such as the Internet, to an advertising distribution server 106 at an advertising site 108 and a broadcast server 110 at a broadcast station site 112. The central server 102 may also connect to the broadcast station site 112 via a satellite 114 or cable link. The broadcaster will select one or more time slots of commercial advertising that are available and, using a web-based application hosted at an application hosting unit 116 at the central server 102, list the time slots on a web site that will be known as the TV advertising (ad) marketplace 118. The TV ad marketplace 118 can be accessed by any user, and specifically the advertiser. The TV ad marketplace 118 will be hosted at the central server 102. The advertiser may access the TV ad marketplace 118 on the central server 102 through the advertising distribution server 106, which contains a display 120 and input device 122 so the advertiser may select one or more time slots available from the broadcaster. Either before or after selecting time slots to make an offer for to purchase, the advertiser will upload one or more commercial advertisements from the advertising distribution server 106 to a management unit 124 at the central server 102. The management unit 124 manages the advertising content uploaded and stored on the central server 102. The advertiser may then select the specific commercial advertisement for broadcast in the selected time slots.

Once the advertiser requests a specific time slot and selects a commercial advertisement for that time slot through the application hosting unit 116, the broadcaster is notified through the management unit 124 and the broadcaster accesses the web-based application to review the commercial advertisement and information on the time slot and programming where the commercial advertisement will be inserted. The broadcaster then uses the web-based application to indicate approval or disapproval of the purchase. If the sale is approved, the management unit 124 handles the processing of the payment from the advertiser and the broadcaster receives payment from the advertiser. If the sale is not approved by the broadcaster—for example if the content is deemed offensive or inappropriate—the sale is canceled and the time slot remains available on the TV ad marketplace 118. The advertiser is then notified that the offer for purchase was not approved.

The selected commercial advertisement is then analyzed by a compatibility unit 126 at the central server 102 to ensure compatibility of the video and audio with that of the broadcaster's broadcast signal. If necessary, the selected commercial advertisement is formatted to the appropriate video and audio specifications. A scheduling unit 128 then schedules the commercial advertisement for transmission to the appropriate TV station 112 at a designated time and creates scheduling information for the broadcast server 110. A transmission unit 130 then uploads the formatted commercial advertisement to the broadcast station site 112 with scheduling information on the particular time slots that the commercial is to be shown. The broadcast station site 112, running a broadcast server 110, processes the scheduling information and stores the commercial advertisement. At the appropriately scheduled time slot, the broadcast server 110 inserts the commercial advertisement into the broadcast video stream for viewing by a television viewer.

In one embodiment, the central server 102 hosts the TV advertising marketplace 118, which includes e-commerce sale and payment features. The broadcaster may list certain time slots during various programming which are available for sale on the TV ad marketplace 118. The available time slots may be listed individually or in blocks, depending on the broadcaster's preference. Further, the broadcaster may accept direct payment through a credit card or Internet-payment system such as Paypal®, or the system may be designed with its own credit system, where an advertiser purchases a certain number of credits which are then applied toward the purchase of one or more time slots. The payment system may be managed at the central site or by an administrator. In another embodiment, the time slots could be sold in an auction-type system, where the time slots are initially listed at a minimum price and the advertisers can place bids the time slots they want to purchase. In one embodiment, the payment from the advertiser to the broadcaster is first deposited with a service organization that will hold the payment until proof of the aired advertisement has been received. This may be in the form of affidavits from the ad server. At this point, the broadcaster will be paid by the service organization.

The web-based applications and other units described above are hosted at the central server 102, but may be managed by a service organization as described above, such as an administrator at a remote server 132 in a remote location 134. The advertisers and broadcasters may pay a fee for use of the web-based application, or a small fee may be charged for each sale of a time slot. Furthermore, the applications may be standard applications resident on the advertising distribution server 106 or broadcast server 110, and simply access the appropriate information from the central server 102 over the network.

In one embodiment, the broadcaster may review the commercial advertisement selected by the advertiser prior to the commercial advertisement being uploaded to the broadcast station site 112. The broadcaster may need to evaluate the content of the commercial advertisement to ensure compliance with rules and regulations on the content of the advertisement, or even verify that the commercial advertisement is appropriate for showing to a particular market, during a particular program or at a particular time slot.

In another embodiment, a broadcaster with several different geographic television markets may be sending the same broadcast signal over separate antennas 136 and 138—for example, one antenna for each geographic television market. In this situation, the broadcaster may place a broadcast server 110 at each transmission site or antenna location so that the broadcaster may insert commercial advertisements unique to each geographic television market. As a result, an advertiser with a business in only one geographic television market would be able to purchase a time slot specific to that geographic television market without spending additional money for commercial advertisement placement in the geographic television markets where it has no interest.

The web-based application provides numerous services to the broadcaster apart from the advertising marketplace. For example, in one embodiment, a scheduling application provides a user interface that helps the broadcaster determine which time slots are available for selling on the advertising marketplace, and the scheduling application will automatically schedule the insertion of commercial advertisements once they are purchased by the advertiser. The broadcast server 110 may be configured to run with the central server 102 to receive selected commercial advertisements and insert them during the appropriate program and time slot. With the scheduling application, the broadcaster is not required to coordinate with the central server 102 or manually input the received commercial advertisements into the broadcast stream.

The central server 102 may also provide compatibility applications for the benefit of both the broadcaster and the advertiser. Recent advancements in video capture and compression technologies permit advertisers to create video content with little or no expense. However, the format of the captured video and audio varies widely depending on the device which captured the video and the network or media upon which the video is stored or transmitted. Therefore, one embodiment of the invention provides a compatibility application which first identifies the properties of any video uploaded by an advertiser. When an advertiser purchases one or more time slots for a particular broadcaster, the compatibility application requests a sample of the broadcast signal for identifying and comparing its properties with those of the commercial advertisement. The sample may be sent by the broadcast server 110 or stored within the central server 102 from previous compatibility analyses. If the video or audio of the commercial advertisement does not match that of the broadcast signal, the commercial advertisement is formatted by converting the audio and video to equivalent or compatible formats. This conversion ensures an unchanged viewing experience between the programming and the inserted content. These formats may pertain to digital audio encoding, standard definition and high definition video signals, signal compression standards, and any other types of video and audio formats. Once the commercial advertisement has been formatted, it is uploaded to the broadcast server 110, where it is then inserted into the broadcast stream for seamless integration into the existing programming. Again, the broadcaster's involvement is minimal since the compatibility application handles the analysis and formatting of the commercial advertisement. The advertiser's involvement is also minimized, although the advantage to the advertiser is the ability to upload almost any type of video and audio content for use as commercial advertising. The advertiser can benefit from significantly reduced production costs and is also able to use the advertising marketplace to purchase low-cost time slots suitable to each advertiser's budget. The broadcaster is able to sell available time slots individually instead of in large blocks and at high prices, as the overhead for finding, scheduling and uploading a commercial advertisement is significantly reduced by the aforementioned system.

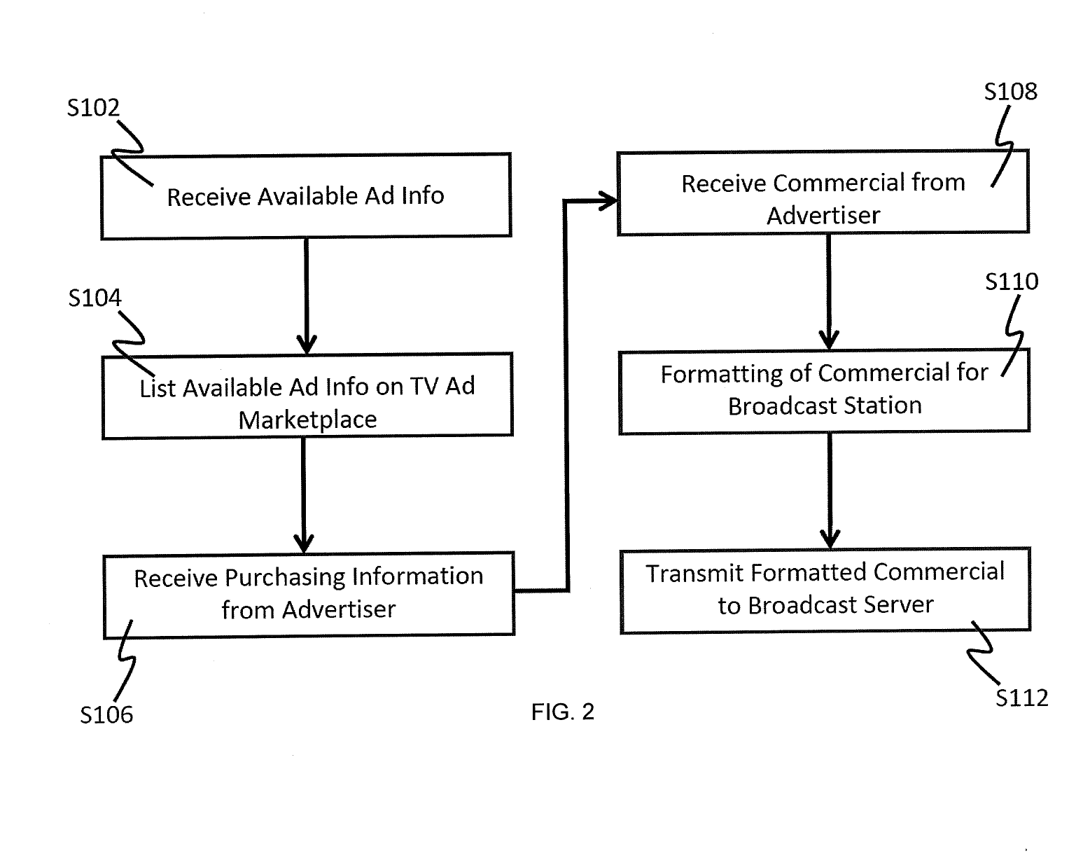

FIG. 2 illustrates one embodiment of a method for managing commercial advertisements in a television broadcast. In a first step S102, the system receives information from at least one broadcaster of at least one time slot to be listed as available for sale. In a second step S104, the system adds the at least one time slot to the advertising marketplace web site, which is displayed to any advertiser. In a third step S106, the system receives purchasing information on a time slot purchased by an advertiser. The system then receives, in step S108, a commercial advertisement video from the advertiser corresponding to the purchased time slot. In step S110, the system analyzes and formats the commercial advertisement based on the broadcast station's broadcast signal. The system then transmits the formatted commercial advertisement to the broadcast server for insertion into the broadcast stream, in step S112.

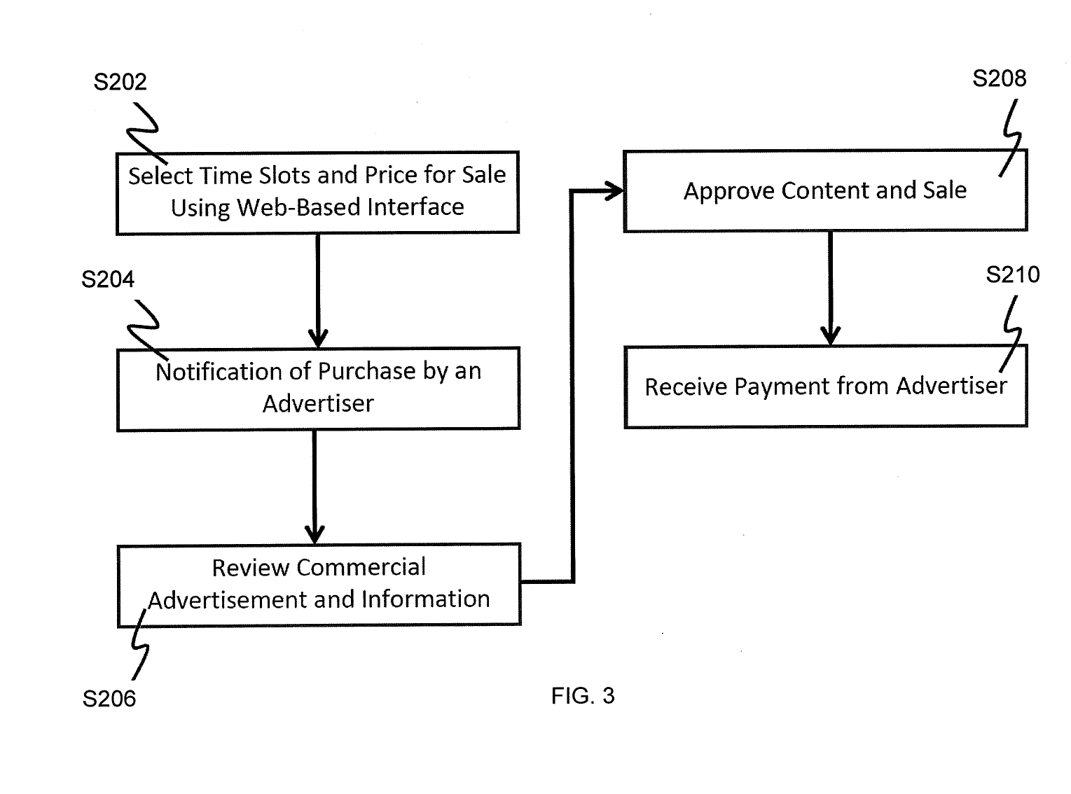

FIG. 3 illustrates one embodiment of a method for selling time slots for commercial advertisements in a television broadcast. In a first step S202, the broadcaster selects at least one time slot to be listed as available for sale and sets a price for the at least one time slot using the web-based interface. In a second step S204, the broadcaster receives a notification that at least one of the time slots has been purchased by an advertiser. In a third step S206, the broadcaster receives the commercial advertisement to review and approve the content, and if desired, the selected time slot, channel and corresponding programming. Assuming the advertisement is acceptable, the broadcaster then approves the sale and the commercial advertisement in step S208. Payment from the advertiser corresponding to the purchased time slot occurs in step S210, after which the system then transmits the formatted commercial advertisement to the broadcast server for insertion into the broadcast stream. In one embodiment, the payment from the advertiser is first received by the service administrator, as set forth above.

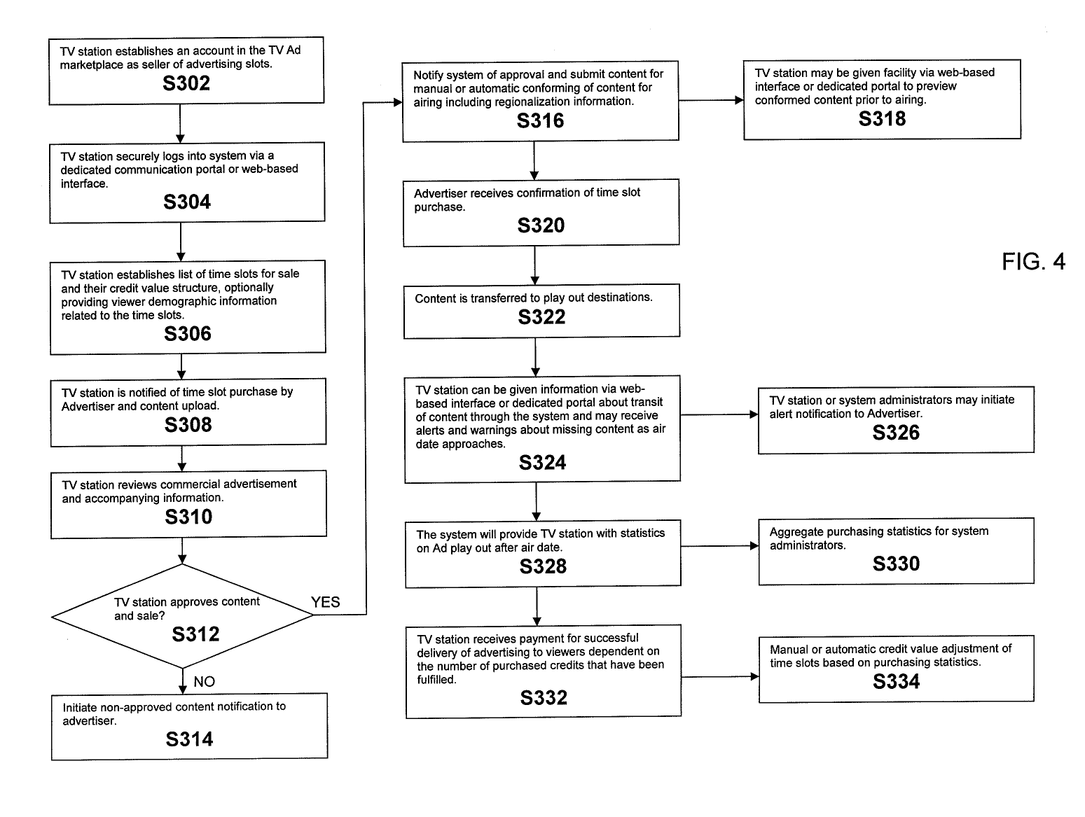

FIG. 4 illustrates another embodiment of a method for selling time slots for commercial advertisements in a television broadcast. In a first step S302, the television broadcast station establishes an account in the TV ad marketplace as a seller of advertising slots using the web-based interface or contact with the system administrators for approval. In a second step S304, the television broadcaster securely logs into the system via a dedicated communication portal or web-based interface. In a third step S306, the television broadcaster establishes a list of time slots for sale and their respective credit value structure. Optionally, the broadcaster provides viewer demographic information related to the available time slots. In one embodiment, the available time slots take the form of automated ingest of schedules from the broadcaster's existing TV delivery system. In a fourth step S308, the television broadcaster is notified of a time slot purchase by an advertiser and receives content upload. In a fifth step S310, the television broadcaster reviews the commercial advertisement and accompanying information to determine if the content and sale are acceptable. In a sixth step, S312, the content and sale are either approved or disapproved.

If disapproved, the television broadcaster initiates a non-approved content notification to the advertiser via an automated electronic mail (e-mail) message, phone/mobile phone text message, voice message, page to a pager, and/or web interface message (step S314).

If approved, the television broadcaster initiates the notification system of approval (step S316) and submits the received content for manual or automatic conformation for airing, including regionalization information. Depending on the format of the uploaded content, the television broadcaster may be given a facility via a web interface or dedicated portal to preview the conformed content prior to airing (S318). In an eighth step S320, the advertiser receives confirmation of the time slot purchase. In a ninth step S322, the content is transferred to any one or more destination stations for airing. In one embodiment, the television broadcaster can be given information via the web-based interface or dedicated portal regarding the transit of the content through the system and, optionally, may receive alerts and/or warnings regarding missing content as the air date/time approaches (S324). Such alerts and/or warnings may be initiated by television broadcaster administrators via an automated electronic mail (e-mail) message, phone/mobile phone text message, voice message, page to a pager, and/or web interface message (S326). In a tenth step S328, the system provides the television broadcaster with any relevant statistics regarding the Ad play out after the air date. The system administrators may then aggregate purchasing statistics of the Ad (S330), and thereafter manually or automatically adjust the credit value of the time slots based on such statistics (S334). Such adjustment of credit value of time slots may also be linked too seasonal purchasing information and local events. As such, the price determination of time slots may take also into account calendar information. In an eleventh step S332, the television broadcaster receives payment for successful delivery of the Ad to viewers dependent upon the number of purchased credits that have been fulfilled.

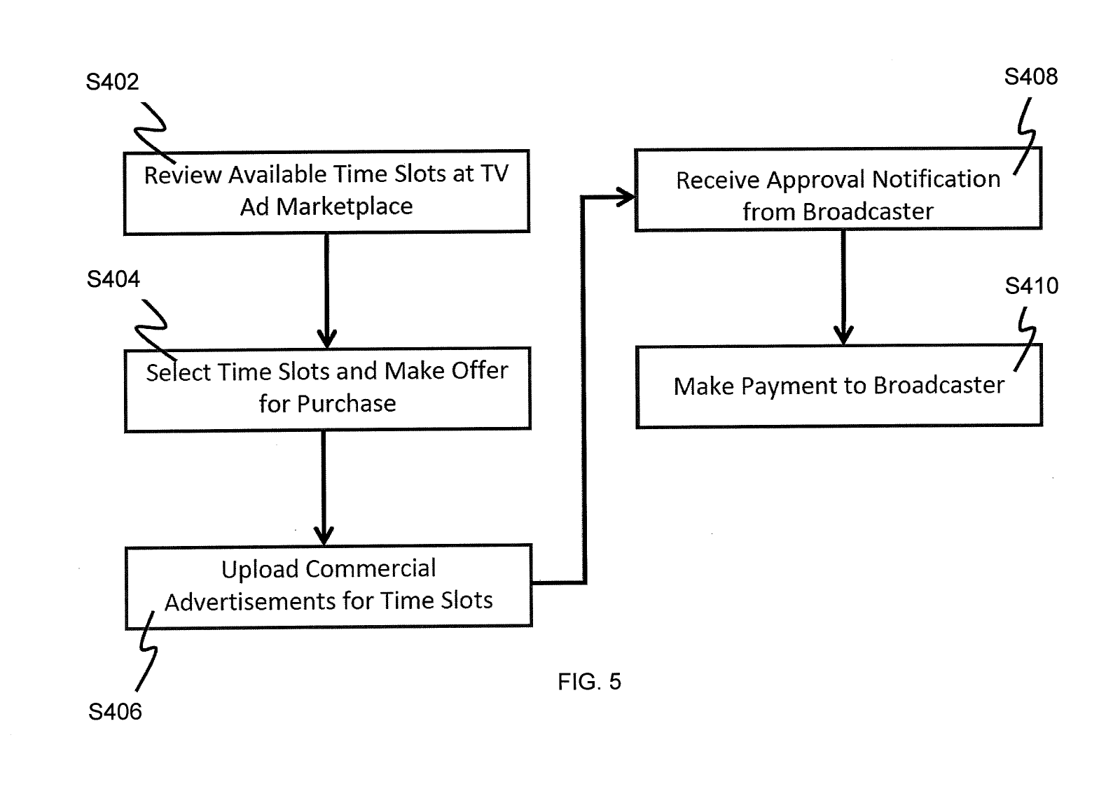

FIG. 5 illustrates one embodiment of a method for purchasing time slots for commercial advertisements in a television broadcast. In a first step S402, the advertiser accesses the TV ad marketplace and reviews the available time slots from at least one broadcaster. In a second step S404, the advertiser selects time slots for purchase and makes an offer for purchase to the broadcaster. In a third step S406, the advertiser uploads at least one commercial advertisement for broadcasting in the selected time slots. Assuming the advertisement is acceptable, the broadcaster then approves the sale and the advertiser receives notification that the sale has been approved in step S408. Payment from the advertiser for the corresponding purchased time slots occurs in step S410, after which the system then transmits the formatted commercial advertisement to the broadcast server for insertion into the broadcast stream. In one embodiment, the payment from the advertiser is first received by the service administrator, as set forth above.

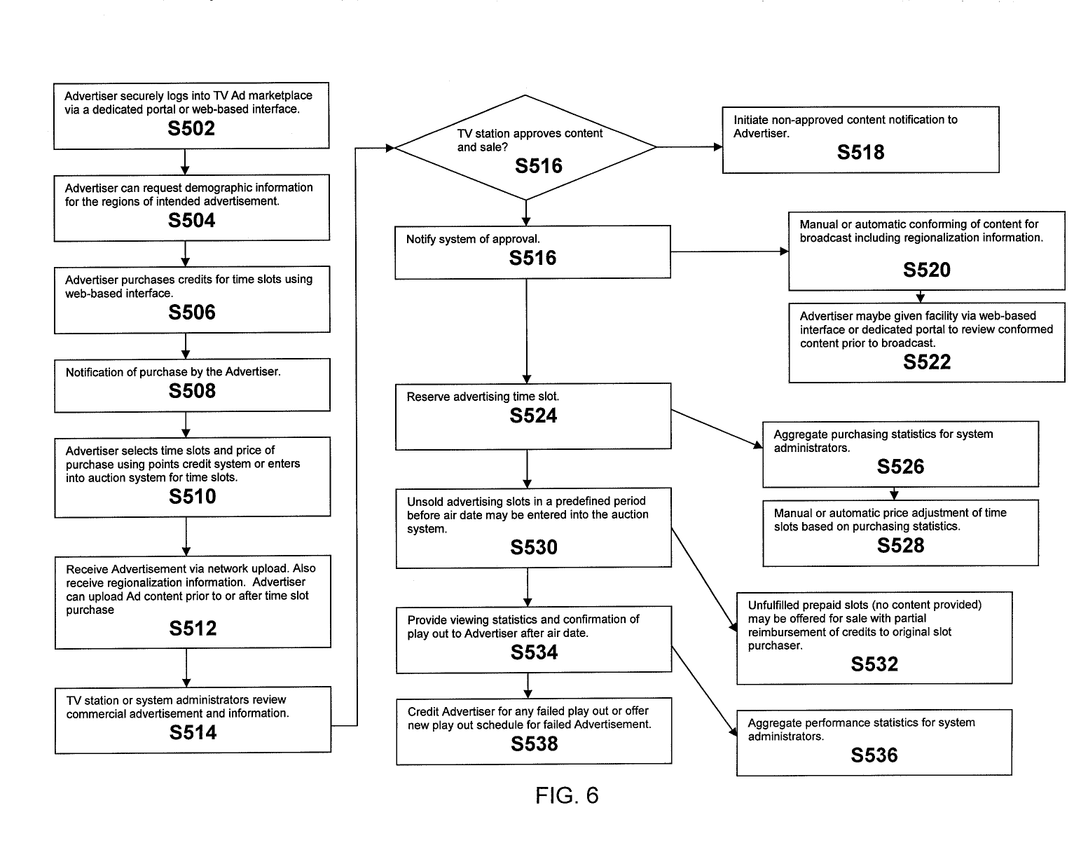

FIG. 6 illustrates another embodiment of a method for purchasing time slots for commercial advertisements in a television broadcast. In a first step S502, the advertiser securely logs into the TV Ad marketplace via dedicated communication portal or web-based interface. In a second step S504, the advertiser requests demographic information for the regions of intended advertisement. In a third step S506, the advertiser purchases credits for time slots using the web-based interface or dedicated portal. In a fourth step S508, the television broadcaster receives notification of the purchase by the advertiser. In a fifth step S510, the advertiser selects time slots and price of purchase using a points credit system or enters into an auction system for the desired time slots. Either prior to or after purchasing one or more time slots, the advertiser uploads Ad content (S512) and optionally receives regionalization information. The Ad content and information is then reviewed by the television broadcaster and/or system administrators (S514) to determine if the content and sale are acceptable. In a sixth step, S516, the content and sale are either approved or disapproved.

If disapproved, the television broadcaster initiates a non-approved content notification to the advertiser via an automated electronic mail (e-mail) message, phone/mobile phone text message, voice message, page to a pager, and/or web interface message (step S518).

If approved, the television broadcaster initiates the notification system of approval and submits the received content for manual or automatic conformation for airing, including regionalization information (step S520). Depending on the format of the uploaded content, the television broadcaster may be given a facility via a web interface or dedicated portal to preview the conformed content prior to airing (S522). The time slot is then reserved for the Ad content (S524).

In a seventh step S526, the system administrators may then aggregate purchasing statistics of the Ad and thereafter manually or automatically adjust the credit value of the time slots based on such statistics (S528). Such adjustment of credit value of time slots may also be linked too seasonal purchasing information and local events. As such, the price determination of time slots may take also into account calendar information.

Any unsold time slots in a predefined period before the air date may then be entered into the auction system for additional Ads and/or advertisers (S530). Any unfulfilled prepaid time slots (i.e., where no content is uploaded/provided for the purchased time slot) may be offered for sale with partial reimbursement of credits to the original slot purchaser. The system then provides the advertiser with any relevant statistics regarding the Ad play out after the air date (S534), and is provided with aggregate performance statistics by system administrators (S536). If for any reason there is a failed advertisement (e.g., the Ad is not aired), the advertiser is credited for the failed play out and/or offered a new play out schedule (S538).

The systems and methods described above are not limited to television advertising, but could be expanded to other commercial advertising such as billboards, radio stations, marquees, point of sale locations and social venues.

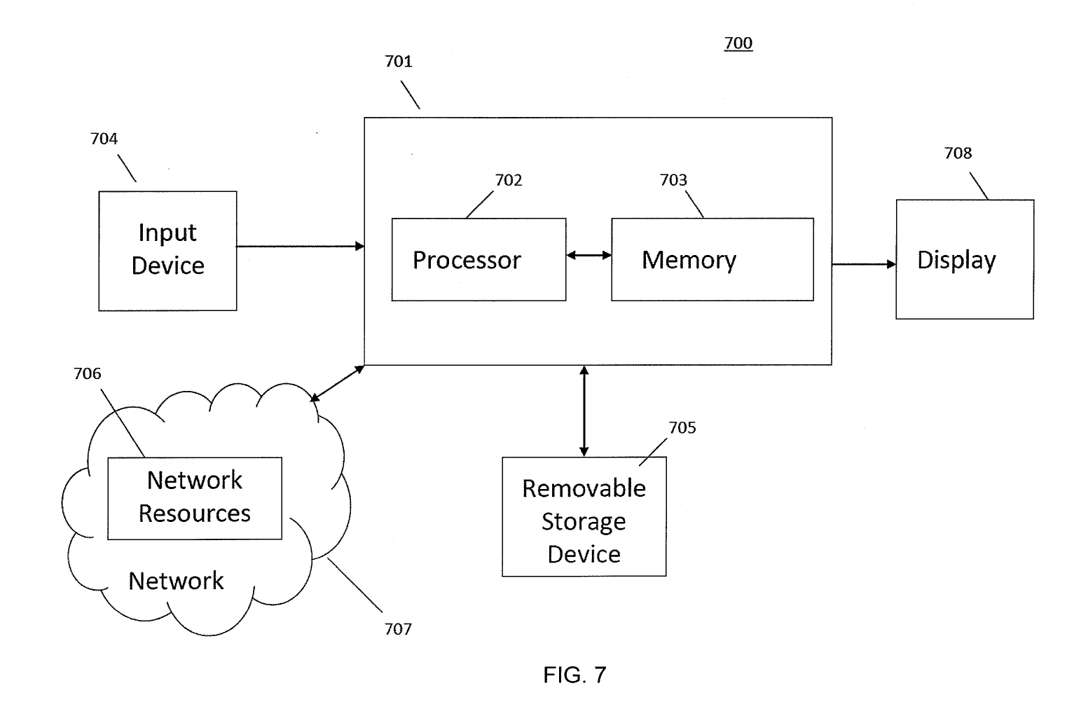

FIG. 7 is a block diagram that illustrates an embodiment of a computer/server system 700 upon which an embodiment of the inventive methodology may be implemented. The system 700 includes a computer/server platform 701 including a processor 702 and memory 703 which operate to execute instructions, as known to one of skill in the art. The term “computer-readable storage medium” as used herein refers to any tangible medium, such as a disk or semiconductor memory, that participates in providing instructions to processor 702 for execution. Additionally, the computer platform 701 receives input from a plurality of input devices 704, such as a keyboard, mouse, touch device or verbal command. The computer platform 701 may additionally be connected to a removable storage device 705, such as a portable hard drive, optical media (CD or DVD), disk media or any other tangible medium from which a computer can read executable code. The computer platform may further be connected to network resources 706 which connect to the Internet or other components of a local public or private network. The network resources 706 may provide instructions and data to the computer platform from a remote location on a network 707. The connections to the network resources 706 may be via wireless protocols, such as the 802.11 standards, Bluetooth® or cellular protocols, or via physical transmission media, such as cables or fiber optics. The network resources may include storage devices for storing data and executable instructions at a location separate from the computer platform 701. The computer interacts with a display 708 to output data and other information to a user, as well as to request additional instructions and input from the user. The display 708 may therefore further act as an input device 704 for interacting with a user.

1-23. (canceled)

24. A system for managing commercial advertising in a television broadcast and bypassing traditional sales contracts between broadcasters and advertisers, comprising:
a television advertisement marketplace that can be accessed by multiple broadcasters and advertisers which displays at least one available time slot for broadcasting the commercial advertisement on at least one television broadcast to an advertiser;
a management unit that enables the broadcasters to establish an account in the system in order to receive advertisement materials, wherein the advertisers purchase credit points that are used as flexible buying options for advertisement slots and allow instant scalability of the buying options;
a central server that processes payment via the purchased credit points for an aired commercial advertisement and converts the credit points for financial reimbursement to the broadcasters for the aired commercial advertisement after the broadcaster confirms airing of the commercial advertisement.

25. The system of claim 24, further comprising a compatibility unit which analyzes the video and audio properties of the commercial advertisement and automatically formats the commercial advertisement to be compatible with the video and audio properties of at least one television broadcast, wherein the compatibility unit is a computer with a processor and a memory.

26. The system of claim 24, wherein the broadcaster confirms the airing of the commercial advertisement via a report transmitted by a broadcast server.

27. A system for selling at least one time slot for commercial advertisements in a television broadcast, comprising:
an application hosting unit which receives information on at least one time slot from a broadcaster that is to be offered for sale using a system of credits;
a central computer server which hosts a television advertisement marketplace which displays at least one available time slot to an advertiser;
a management unit which receives information on a time slot selected by the advertiser and which notifies the broadcaster of an offer for purchase;
wherein the application hosting unit provides the broadcaster with information on the commercial advertisement for review and approval; and
wherein approval of the commercial advertisement by the broadcaster permits processing of credit points by the service organization and transmission of the commercial advertisement to a television broadcast station.

28. The system of claim 27, further comprising a broadcast server at the television broadcast station which inserts the commercial advertisement into at least one television broadcast.

29. A central computer server which hosts a method for selling at least one time slot for commercial advertising in a television broadcast, comprising the steps of:
selecting at least one time slot for sale based on a credit points value of the slot;
receiving notification of an offer for purchase of at least one time slot from an advertiser;
reviewing a commercial advertisement corresponding to the offer for purchase;
approving the commercial advertisement and sale of the at least one time slot.

30. The method of claim 29, further comprising disapproving the commercial advertisement and sale of at least one time slot and reimbursing credit points to the advertiser.

31. The method of claim 29, further comprising aggregating points value statistics of at least one time slot and adjusting the credit points value of the time slot.

32. A system for purchasing at least one time slot for commercial advertisements in a television broadcast, comprising:
a central server which hosts a television advertisement marketplace which displays at least one available time slot to an advertiser; and
an application hosting unit which receives at least one request for purchase of at least one time slot from an advertiser;
a management unit which receives at least one commercial advertisement corresponding to the advertiser's request for purchase;
wherein the management unit notifies the advertiser if the request for purchase has been approved by a broadcaster; and
wherein the management unit handles the processing of the payment from the advertiser and conversion into credits.

33. A method for purchasing at least one time slot for commercial advertising in a television broadcast, comprising the steps of:
reviewing at least one time slot for sale in a television advertisement marketplace;
selecting at least one time slot and making an offer for purchase using credit points which have been pre-paid;
transmitting at least one commercial advertisement to a broadcaster, at least one commercial advertisement corresponding to the selected for at least one time slot;
receiving approval from the broadcaster for at least one commercial advertisement; and
converting the points credit value of the slot into a monetary value, providing payment to the broadcaster for at least one approved time slot.

34. A computer program product for purchasing at least one time slot for commercial advertising in a television broadcast, the computer program product embodied on a computer readable medium and when executed by a computer, performs the method comprising:
reviewing at least one time slot for sale in a television advertisement marketplace;
selecting at least one time slot and making an offer for purchase using credit points which have been pre-paid;
transmitting at least one commercial advertisement to a broadcaster, at least one commercial advertisement corresponding to the selected for at least one time slot;
receiving approval from the broadcaster for at least one commercial advertisement; and
converting the points credit value of the slot into monetary form, providing payment to the broadcaster for at least one approved time slot.
